(19) United States
(12) Patent Application Publication
(10) Pub. No.: US 2019/0303803 A1
(43) Pub. Date: Oct. 3, 2019

(54) METHOD AND SYSTEM FOR PROVIDING DIGITAL COMPENSATION

(71) Applicant: Mastercard International Incorporated, Purchase, NY (US)

(72) Inventors: Nicolas BUC, Larchmont, NY (US); Alexandra Kiernan, New York, NY (US); George Edward Zilvetti, Glen Rock, NJ (US); Anne Valentzas, Irvington, NY (US); Thomas Bittlemann, Stamford, CT (US)

(73) Assignee: Mastercard International Incorporated, Purchase, NY (US)

(21) Appl. No.: 15/941,460

(22) Filed: Mar. 30, 2018

(51) Int. Cl. G06Q 10/02; G06Q 20/34; G06Q 20/36

(52) U.S. Cl. CPC G06Q 10/02; H04L 67/12; G06Q 20/36; G06Q 20/348

(57) ABSTRACT

A method for providing digital compensation can include receiving information from a merchant server including a change condition and/or instructions to communicate with a customer. The processor can determine a communication to deliver to the customer and receive one or more selections from the customer. Based on information received from the merchant server and information received from the customer, the processor can determine a type and amount of digital compensation to be provided to the customer, including any parameters to apply to the compensation. The processor can then provide digital compensation to the customer. Following the determination of digital compensation to be provided, information regarding events and experiences and other offers may be communicated to the customer. Following the provision of digital compensation, the system can also monitor the redemption status of the digital compensation.

### BACKGROUND

The disclosed subject matter relates to methods and systems for providing digital compensation to customers.

Merchants such as the airline industry frequently experience customer service issues such as overbooked, canceled, or delayed flights, or lost or damaged luggage. To help maintain the customer satisfaction during such customer service issues (e.g., in the case of a canceled or delayed flight, or in the event that a passenger's luggage is lost or damaged), an airline might want to provide compensation to the passenger. For example, airlines might offer airline vouchers in exchange for passengers forfeiting their seat on an overbooked flight. Airlines might offer food and drink vouchers for use in the airport while passengers wait for their flight. In the event of a delayed or canceled flight, airlines might also offer hotel vouchers for use at hotels near the airport. In the event of damaged or lost luggage, an airline might offer vouchers redeemable for new luggage.

Currently, airlines provide paper vouchers for use on new flights, hotel accommodations, and for use in the airport terminal, for example for food and beverages. To provide paper vouchers, an airline agent must manually enter the information of the passenger who, voluntarily or involuntarily, will be forfeiting their seat to be re-booked on another flight and to be provided a voucher. With hundreds of thousands of overbookings every year in the United States alone, providing paper vouchers represents a large amount of waste, both in the paper and toner used to print the vouchers and in the unanticipated time that airline agents must use to select passengers, determine their new itinerary, provide new tickets, and then provide paper vouchers. In addition to the waste and expense on the part of airlines, customer time is wasted and customer experience is negatively impacted by the associated inconveniences, for example by passengers receiving the notification of an overbooked flight only once the passenger has arrived at the airport, or by having to be given a paper voucher that can be easily lost or destroyed. Accordingly, there exists a long-felt need for providing digital compensation to customers in the event of irregular operations that might cause customer inconvenience, to reduce or remove the usage of paper vouchers and to enhance customer experience rather than diminish it. In addition, there exists a need for notifying customers within a reasonable time before an irregular operation might inconvenience them.

### SUMMARY

The purpose and advantages of the disclosed subject matter will be set forth in and apparent from the description that follows, as well as will be learned by practice of the disclosed subject matter. Additional advantages of the disclosed subject matter will be realized and attained by the methods and systems particularly pointed out in the written description and claims hereof, as well as from the appended drawings.

To achieve these and other advantages and in accordance with the purpose of the disclosed subject matter, as embodied and broadly described, a method for providing digital compensation is disclosed.

For purposes of illustration and not limitation, the method can include receiving, by processing circuitry, a notification from a merchant, of a change condition regarding a customer and receiving instructions from the merchant, specifying at least one type of digital compensation to offer to the customer, an amount or amounts of compensation to offer to the customer, and at least one parameter to apply to compensation. The method can include determining, by the processing circuitry, a communication to send to the customer. The processing circuitry can transmit the communication to the customer. The processing circuitry can receive at least one selection from the customer. The method can include determining, by the processing circuitry, based on the at least one selection from the customer, whether to provide compensation to the customer. The processing circuitry can determine, based on the at least one selection from the customer, a compensation type and a compensation amount to provide to the customer. The processing circuitry can transmit digital compensation to the customer based on the instructions from the merchant and the at least one selection from the customer.

For purpose of illustration and not limitation, the method can include communication to the customer of the option to forego services in exchange for digital compensation.

For purpose of illustration and not limitation, the method can include the merchant being an airline. The change condition can include one of a delayed flight, a canceled flight, or an overbooked flight, the communication transmitted to the customer can include an option to forfeit the customer's seat in exchange for digital compensation, and in some embodiments, the type of digital compensation can include a digitally transmitted airline voucher.

For purpose of illustration and not limitation, in one implementation, the method can include the merchant being an airline, the change condition can be one of a delayed flight, an overbooked flight, or a canceled flight and the communication to the customer can include an option to select a type of digital compensation, including one of a digitally transmitted airline voucher, or digital compensation to which at least one parameter is applied to restrict redemption of the digital compensation to a particular place or to restrict redemption of the digital compensation to a particular time.

For purpose of illustration and not limitation, the method can include determining, by the processing circuitry, relevant information for the customer, based on a departure location of the delayed flight, a departure location of the overbooked flight, or a departure location of the canceled flight, and can include transmitting the information to the customer.

For purpose of illustration and not limitation, the method can include the merchant being an airline, the change condition being one of a delayed flight or an overbooked flight, the communication to the customer can include an option to forfeit a seat in exchange for digital compensation, and the type of compensation can include a digitally transmitted airline voucher. The method can include monitoring, by the processing circuitry, a redemption status of the digital compensation. The method can include transmitting, by the processing circuitry to the merchant, a notification that the digital compensation has been partially or fully redeemed.

For purpose of illustration and not limitation, the method can include providing digital compensation, by the processing circuitry, in the form of a virtual prepaid gift card.

For purpose of illustration, and not limitation, the method can include providing digital compensation, by the processing circuitry, to a digital wallet associated with the customer.

For purpose of illustration, and not limitation, the parameter to apply to the digital compensation can include at least one customer loyalty benefit.

For purpose of illustration, and not limitation, the method can include the merchant providing accommodations, the at least one parameter to apply to the digital compensation can include limiting use of the digital compensation to one of a selected restaurant or a selected service provider, and the method can include monitoring, by the processing circuitry, a redemption status of the digital compensation and transmitting, by the processing circuitry to the merchant, a notification that the digital compensation has been partially or fully redeemed.

In accordance with another aspect of the disclosed subject matter, a system for providing digital compensation is disclosed. The system can include processing circuitry configured to receive a notification, from a merchant, of a change condition regarding a customer and can be further configured to receive, from the customer, at least one selection. The system can include the processing circuitry being further configured to receive instructions from the merchant, specifying at least one type of digital compensation to offer to the customer, an amount or amounts of compensation to offer to the customer, and at least one parameter to apply to compensation. The method can include the processing circuitry being configured to determine a communication to send to the customer, to transmit the communication to the customer, to determine, based on the at least one selection from the customer, whether to provide compensation to the customer, and to determine, based on the at least one selection from the customer, a compensation type and a compensation amount to provide to the customer. The system can include the processing circuitry being configured to provide digital compensation to the customer of the type and amount selected, based on the instructions from the merchant and the at least one selection from the customer.

For purpose of illustration and not limitation, the system can include the processing circuitry being configured to transmit the communication to the customer including the option to forego services in exchange for digital compensation.

For purpose of illustration and not limitation, the system can include the merchant being an airline, the change condition can include one of a delayed flight, a canceled flight, or an overbooked flight, the communication to the customer can include an option to forfeit the customer's seat in exchange for digital compensation, and the type of digital compensation can include a digitally transmitted airline voucher.

For purpose of illustration and not limitation, the system can include the merchant being an airline, the change condition can include a delayed flight, an overbooked flight, or a canceled flight, and the communication to the customer can include an option to select a type of digital compensation, which can include one of a digitally transmitted airline voucher, or digital compensation to which at least one parameter can be applied to restrict redemption of the digital compensation to a particular place or to restrict redemption of the digital compensation to a particular time.

For purpose of illustration and not limitation, the system can include the processing circuitry being further configured to determine information relevant to the customer based on a departure location of the delayed flight, a departure location of the overbooked flight, or a departure location of the canceled flight. The system can include the processing circuitry being further configured to transmit the information to the customer.

For purpose of illustration and not limitation, the system can include the merchant being an airline, the change condition can include a delayed flight, an overbooked flight, or a canceled flight, the communication to the customer can include an option to give up a seat in exchange for digital compensation. For example and not limitation, the type of compensation can include a digitally transmitted airline voucher. The system can also include the processing circuitry being further configured to monitor a redemption status of the digital compensation and to transmit to the merchant, a notification that the digital compensation has been partially or fully redeemed.

For purpose of illustration and not limitation, the system can include the processing circuitry being configured to provide the digital compensation in the form of a virtual prepaid gift card.

For purpose of illustration and not limitation, the system can include the processing circuitry being further configured to provide the digital compensation to a digital wallet associated with the customer.

For purpose of illustration and not limitation, the system can include the at least one parameter to apply to the digital compensation including at least one customer loyalty benefit.

For purpose of illustration and not limitation, the system can include the merchant providing accommodations. The system can include the at least one parameter to apply to the digital compensation including limiting use of the digital compensation to one of a selected restaurant or a selected service provider. The system can include the processing circuitry being further configured to monitor a redemption status of the digital compensation and transmit to the merchant, a notification that the digital compensation has been partially or fully redeemed.

It is to be understood that both the foregoing general description and the following detailed description are exemplary and are intended to provide further explanation of the disclosed subject matter claimed.

The accompanying drawings, which are incorporated in and constitute part of this specification, are included to illustrate and provide a further understanding of the disclosed subject matter. Together with the description, the drawings serve to explain the principles of the disclosed subject matter.

### BRIEF DESCRIPTION OF THE DRAWINGS

FIG. 1 is a diagram illustrating a representative payment network according to an illustrative embodiment of the disclosed subject matter.

FIG. 2 is a diagram illustrating a system for providing digital compensation according to an illustrative embodiment of the disclosed subject matter.

FIG. 3 is a flow chart illustrating a representative method, for providing digital compensation, implemented according to an illustrative embodiment of the disclosed subject matter.

FIG. 4 is a block diagram illustrating further details of a representative computer system according to an illustrative embodiment of the disclosed subject matter.

Throughout the drawings, the same reference numerals and characters, unless otherwise stated, are used to denote like features, elements, components or portions of the illustrated embodiments. Moreover, while the present disclosed subject matter will now be described in detail with reference to the figures, it is done so in connection with the illustrative embodiments.

### DETAILED DESCRIPTION

According to an aspect of the disclosure, digital compensation can be provided to passengers in many forms, including but not limited to payment sent to a digital wallet associated with a customer, via direct debit to a debit account, or via virtual prepaid gift cards. In addition, there exists a need for notifying customers before an irregular operation might inconvenience them, for example for notifying a passenger of an airline before they check in for their flight, that their flight is overbooked and presenting the passenger with the option of forfeiting their seat in exchange for digital compensation of some type and amount, with some predetermined parameters for use. Such a notification may be generated such that it can be received by the customer via a customer device. The communication transmitted to the customer device can include, but is certainly not limited to SMS, social network account message, e-mail, communication via an interactive website, or any other communications medium or interface.

Among many others, an added benefit of replacing paper vouchers with digital compensation is that compensation provided digitally can be monitored much more easily than traditional paper vouchers. Currently, vouchers must be manually accounted for as they are provided. With digital compensation, merchants may be alerted to the redemption status of digital vouchers provided to customers as they are redeemed and the disclosed system may thereby act as a transaction accounting system after providing digital compensation. In addition, parameters can be applied automatically to digital compensation. For example, a digital voucher can be provided for use only during a certain time period and can be cleared from a customer's account or digital wallet, or simply become inactive after that certain time period has passed. A merchant can be notified or have access to this information so that outstanding vouchers can be much more easily and efficiently monitored.

Even without experiencing an irregular operation issue, merchants, whether airlines or otherwise, might want to provide benefits to customers for many reasons, for which digital compensation can provide efficient solutions. For example, and not by way of limitation, digital compensation can be provided to reward customer loyalty and/or to provide special benefits. In this manner, digital compensation can be provided not only to respond to potential customer inconvenience or in exchange for explicit customer actions (for example, an airline providing a voucher in exchange for a passenger forfeiting a seat on a flight), but also to enable merchants to deliver benefits or rewards in response to desirable customer activity, i.e. to provide digital compensation, either explicitly or implicitly, in recognition of, from the merchant's perspective, desirable customer activity or commerce (for example, an airline providing an award of airline miles in recognition of a customer's repeat business). For example, and not by way of limitation, hotels might provide free breakfast or discounted tickets to events or vouchers for use at service providers of the hotel or in the surrounding area. In the case of gratuitous meals or tickets or reservations booked through a hotel's concierge, the systems and methods disclosed herein can monitor whether guests actually take part in the activities or use the services that they plan by monitoring redemption of a digital voucher or other digital compensation, such as a voucher-less digital transaction, by providing them as digital compensation.

To achieve these and other advantages and in accordance with the purpose of the disclosed subject matter, as embodied and broadly described, a method for providing digital compensation is disclosed.

Reference will now be made in detail to the various exemplary embodiments of the disclosed subject matter, exemplary embodiments of which are illustrated in the accompanying drawings. The structure and corresponding method of operation of the disclosed subject matter will be described in conjunction with the detailed description of the system.

The methods and systems presented herein can be used for providing digital compensation.

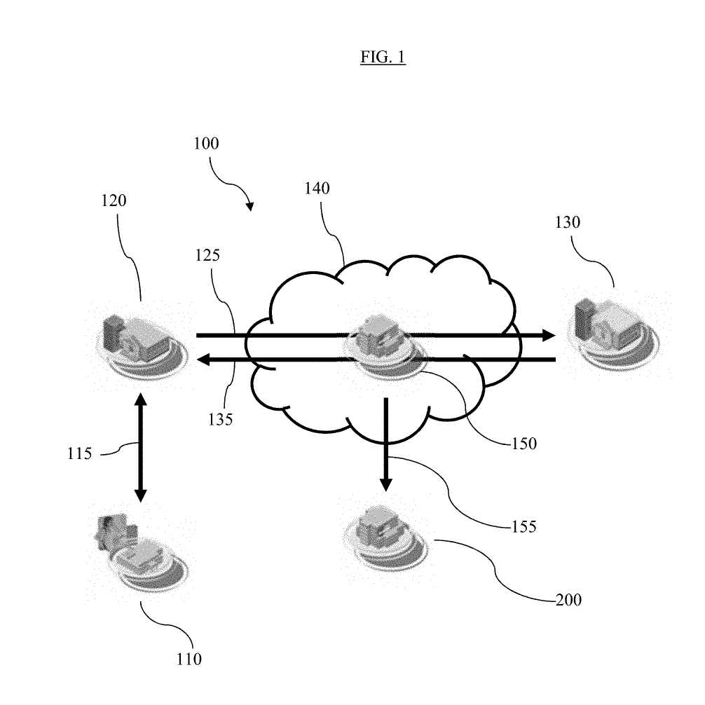

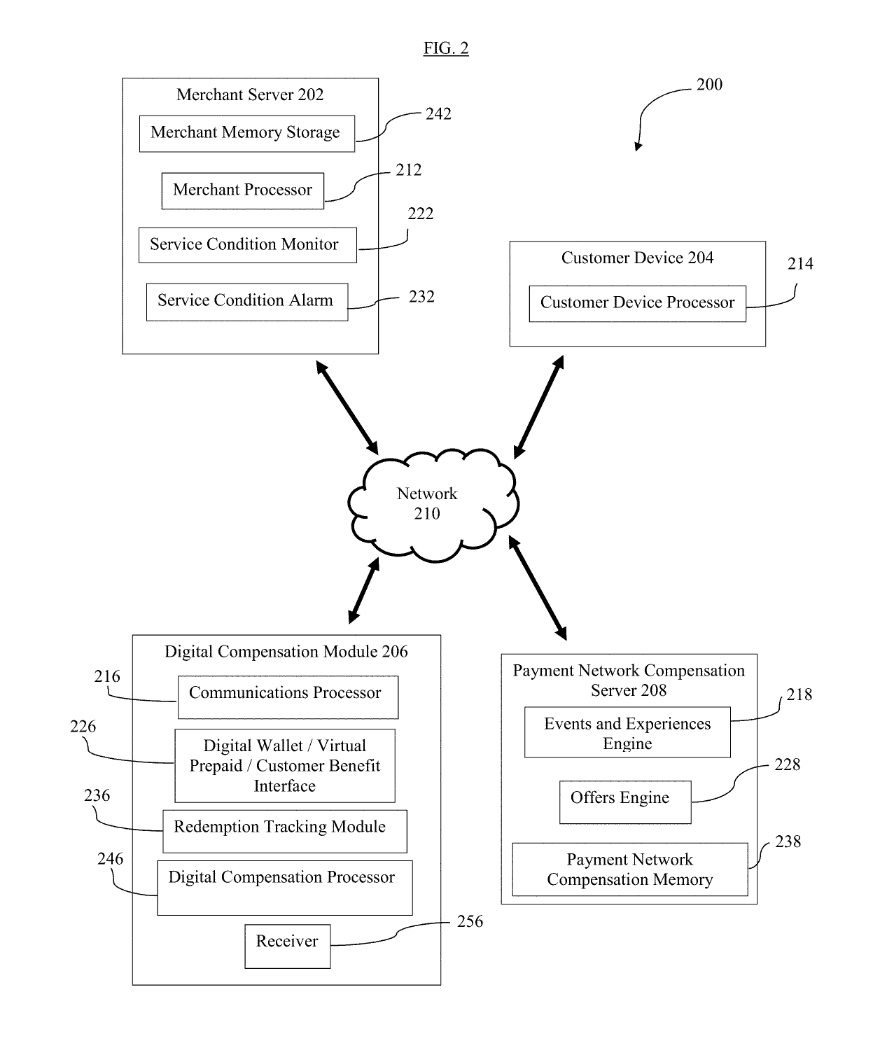

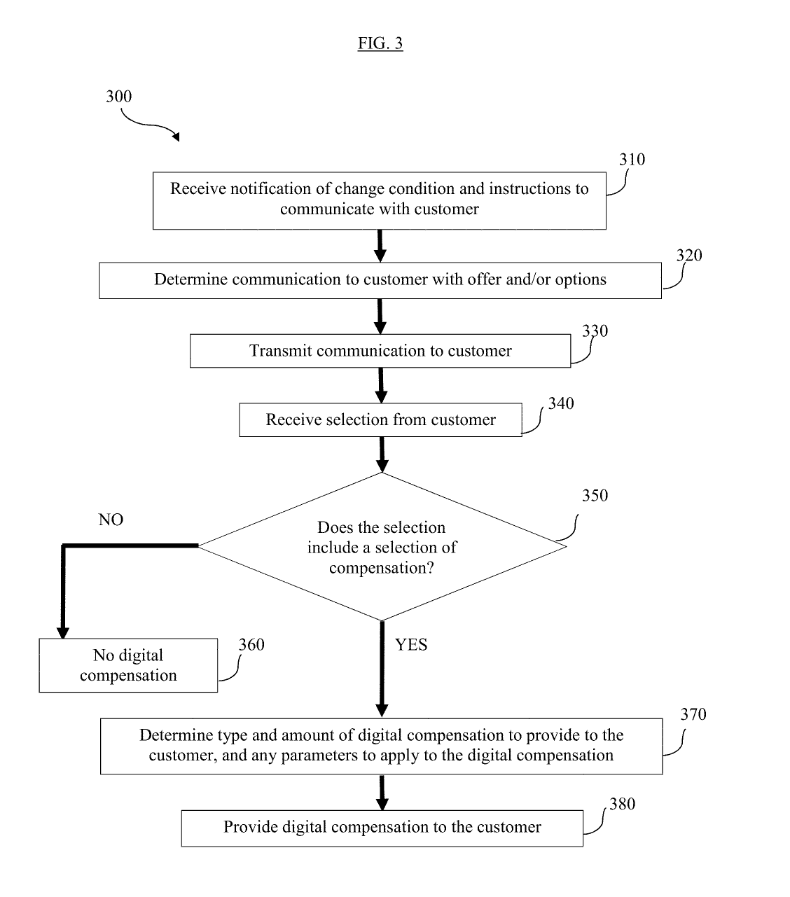

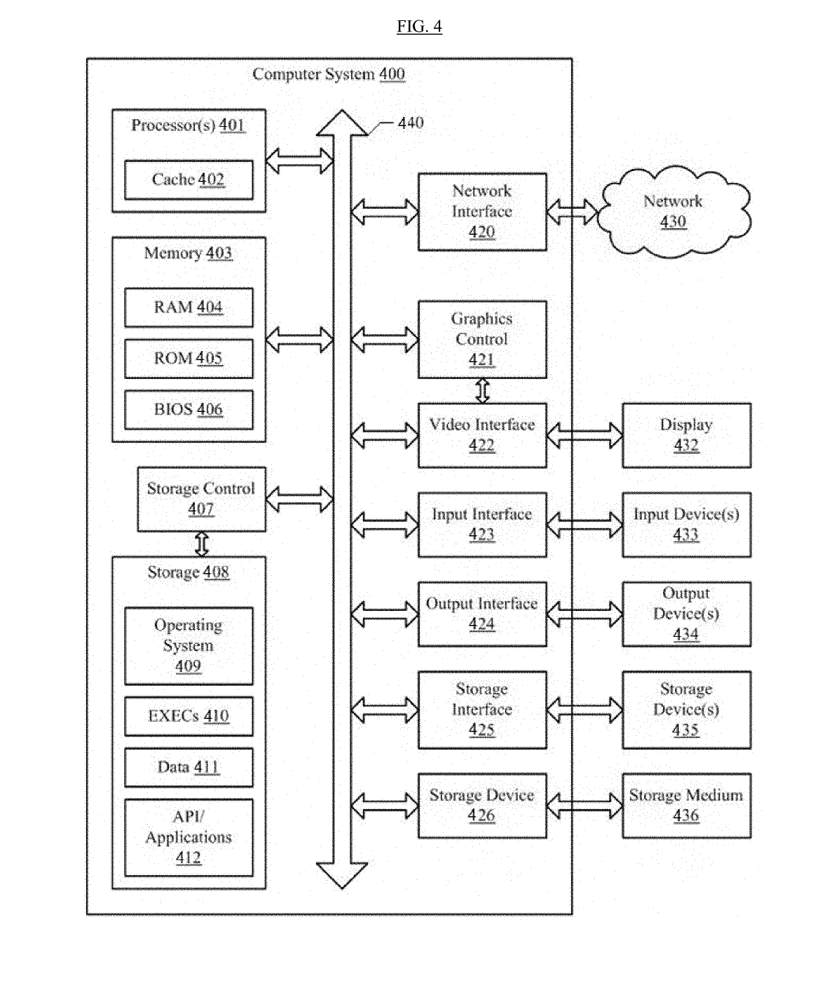

The accompanying figures, where like reference numerals refer to identical or functionally similar elements throughout the separate views, further illustrate various embodiments and explain various principles and advantages all in accordance with the disclosed subject matter. For purpose of explanation and illustration, and not limitation, an exemplary embodiment of a payment network for providing digital compensations in accordance with the disclosed subject matter is shown in FIG. 1. FIG. 2 shows an exemplary block diagram of a system for providing digital compensation in accordance with the disclosed subject matter. FIG. 3 shows an exemplary embodiment of a method for providing digital compensation in accordance with the disclosed subject matter. An exemplary embodiment of a computer system for use with the disclosed subject matter is shown in FIG. 4. While the present disclosed subject matter is described with respect to using methods and systems for providing digital compensation, one skilled in the art will recognize that the disclosed subject matter is not limited to the illustrative embodiments. For example, the methods and systems for providing digital compensation can be used to facilitate transactions of different types, to monitor the activity of digital accounts, and to enhance the customer experience and increase merchant-side efficiency.

FIG. 1 depicts a diagram illustrating a representative payment network 100 according to an illustrative embodiment of the disclosed subject matter. Payment network 100 can allow for payment transactions in which merchants and card issuers do not necessarily have a one-to-one relationship. The payment network 100, for example and without limitation a credit card payment system, can utilize an electronic payment network 140, such as the Mastercard® payment card system interchange network. The Mastercard® payment card system interchange network is a proprietary communications standard promulgated by Mastercard International Incorporated® based on the ISO 8583 message format for the exchange of financial transaction data between financial institutions that are customers of Mastercard International Incorporated. (Mastercard is a registered trademark of Mastercard International Incorporated located in Purchase, N.Y.)

As embodied herein, the payment network 100 can be used for providing digital compensation to a customer. The payment network 100 can include at least one merchant 110 connected to at least one electronic payment network 140, either directly or through an acquirer 120 via connection 115. At least one acquirer 120 can be connected to the electronic network 140, and each merchant 110 can be in communication with at least one acquirer 120 via the at least one payment network 140 or connection 115. At least one issuer 130 can be connected to the electronic network 140, and each acquirer 120 can be in communication with at least one issuer 130 via the electronic payment network 140.

For purpose of illustration and not limitation, in payment network 100, a financial institution, such as an issuer 130, can issue an account, such as a credit card account or a debit card account, to a cardholder (e.g., an individual consumer or a corporate or commercial customer), who can use the payment account card to tender payment for a purchase from a merchant 110 or to conduct a transaction at an ATM or website. To accept payment with the payment account card, merchant 110 can establish an account with a financial institution that is part of the financial payment system. This financial institution can be referred to as the “merchant bank” or the “acquiring bank,” or herein as “acquirer 120.” When a cardholder tenders payment for a purchase with a payment account card, the merchant, ATM, or website 110 can request authorization from acquirer 120 for the amount of the purchase. The request can be performed over the telephone, online via a web site, or through the use of a point-of-sale terminal which can read the cardholder's account information from the magnetic stripe on the payment account card, from a smart card using contact pads, contactlessly from a near-field communication (NFC) device, or from manual entry and communicate electronically with the transaction processing computers of acquirer 120. Alternatively, acquirer 120 can authorize a third party to perform transaction processing on its behalf. In this case, the point-of-sale terminal can be configured to communicate with the third party. Such a third party can be referred to as a “merchant processor” or an “acquiring processor.”

As embodied herein, using payment network 140, the computers of acquirer 120 or the merchant processor can communicate information regarding payment card transactions with computers of the issuer 130. For example and not limitation, information regarding payment card transactions can include an authorization request 125 and an authorization response 135. An authorization request 125 can be communicated from the computers of the acquirer 120 to the computers of issuer 130 to determine whether the cardholder's account is in good standing and whether the purchase is covered by the cardholder's available credit line or account balance. Based on these determinations, the authorization request 125 can be declined or accepted, and an authorization response 135 can be transmitted from the issuer 130 to the acquirer 120, and then to the merchant, ATM, or website 110. The authorization request 125 can include account information identifying the merchant, location information (e.g., an address of the merchant), and transaction information, as discussed herein. The authorization response 135 can include, among other things, a result of the determination that the transaction is approved or declined and/or information about the status of the payment card or payment account.

For example and not limitation, at least one payment network server 150 can be connected to the electronic payment network 140 and configured to automatically capture the data representing a plurality of variables related to payment card transactions from the electronic payment network 140. As embodied herein, the payment network server 150 can be configured to only capture the data representing a plurality of variables related to payment card transactions with the permission of the cardholder. Additionally, the payment network server 150 can be configured to only capture the information regarding payment card transactions in accordance with applicable data privacy laws.

For example, and not limitation, payment network 100 can monitor redemption of digital compensation, whether or not the payment network 100 processes transactions resulting from a customer's receipt of digital compensation.

FIG. 2 depicts a block diagram illustrating a representative system 200 for providing digital compensation.

For example, and not limitation, the Merchant Server 202, which can be controlled, managed, and operated by merchant 110, can include a merchant processor 212, a service condition monitor 222, a service condition alarm 232, and merchant memory storage 242. For example, and not limitation, merchant server 202 can be a part of third party computing system. For example, and not limitation, merchant server 202 can be housed in the same or different location as the digital compensation module 206. For example, and not limitation, merchant server 202 may be configured to communication with digital compensation module 206 and its subcomponents via an application program interface (API).

For example, and not limitation, the Customer Device 204 can include a Customer Device Processor 214. The customer device 204 can be one of a number of devices, including but not limited to devices that are used to access or monitor customer account information or to make payments, such as cellular telephones, laptop computers, smart watches, tablets, and other networked devices that may be configured to function as NFC devices.

As embodied herein, digital compensation module 206 can include a digital compensation processor 246, a redemption tracking module 236, a communications processor 216, a digital wallet/virtual prepaid/customer benefit interface 226, and a receiver 256.

As embodied herein, payment network compensation server 208 can include an events and experiences processor 218, an offers engine 228, and payment network compensation memory 238.

For example, and not limitation, the merchant memory storage 242 can be configured to contain a variety of information, including but not limited to, for example, customer data, sales data, pricing data, data regarding previous and current offers, and other operational merchant-side data. The service condition monitor 222 can be configured to monitor operational merchant data and determine whether and when one of a possible number of service conditions has occurred or will occur within a certain time period. For example, and not limitation, the service condition monitor 222 can be in communication with the service condition alarm 232, which can be configured to communicate the condition to the digital compensation module 206.

For example, and not limitation, in the case of a merchant airline, the service condition monitor 222 can be configured to monitor flight schedules and ticket records of flights. In this manner, the service condition monitor 222 can be configured to determine if a flight is delayed, canceled, or whether a flight has been overbooked. In the case of an overbooked flight, the service condition monitor 222 can be configured to communicate to the service condition alarm 232 only if there is a certain period of time between the time that the overbooking is realized and the scheduled flight time. In that manner, potentially problematic overbookings can be determined. For example, and not limitation, the alarm 232 can be configured to communicate the status condition to the digital compensation module 206 if, at a certain point in time prior to the scheduled time of service, a potentially problematic condition exists. For example, and not by way of limitation, the alarm 232 can be configured to communicate a change condition to the digital compensation module 206 if, for example, a flight is overbooked as of 24 or 36 hours before the flight is scheduled to depart, or as soon as possible based on the information in merchant memory storage 242. In some embodiments, digital compensation module 206 can be configured to access service condition information from merchant memory storage 242 and can be configured to determine when a change condition occurs.

For example, and not limitation, in the case of a merchant offering accommodations such as a hotel, the service condition monitor 222 can be configured to monitor operational merchant data to determine, for example, if an event has occurred that might cause the merchant to want to offer a customer one of a certain number of benefits. For example, a merchant hotel might want to offer a returning customer a free meal at the hotel restaurant, or a nearby restaurant, or a free service at a hotel-affiliated or other nearby establishment. Such “contextual commerce” can be enabled by the technology disclosed herein by providing customer benefits for example, as digital compensation.

For example and not limitation, in the context of the airline industry again, the service condition monitor 222 can be configured to monitor lost or delayed luggage, information about which can be stored in merchant memory storage 242, monitored by the service condition monitor 222, and communicated to the service condition alarm 232 if data received or analyzed by the service condition monitor indicates that a passenger's luggage has been lost or damaged. To compensate passengers for lost or damaged luggage, the digital compensation module 206 can be configured to receive notification from the merchant server 202, determine a communication to send to the passenger, communicate such message to the passenger, determine whether digital compensation is appropriate and desired, and provide such digital compensation.

For example and not limitation, the service condition monitor 222 and service condition alarm 232 can be configured to communicate to the digital compensation module 206 any service condition relevant to a merchant's relationship with a customer, or relevant to a customer's experience with the merchant. In some embodiments, the service condition monitor 222 and service condition alarm 232 can both be configured to communicate information to the digital compensation module 206 and such information can be partially or fully redundant.

In some embodiments, the communication from the merchant server 202 can be triggered manually, such as by an agent of the merchant. In some embodiments, an agent of the merchant can manually indicate a change condition to be communicated to the digital compensation module 206. In some embodiments, the manually-triggered communication and/or the manually-indicated change condition can be communicated to the digital compensation module 206 from the merchant server 202 via network 210.

Communications to the digital compensation module 206 from the merchant server 202, via the network 210, can include a variety of merchant data. Such merchant data can include customer data, including customers to whom communications should be subsequently sent and/or customers to whom communications should not be sent. Such merchant data can further include lists of merchant-related offers to be communicated to customers and sets of rules or parameters to apply to those offers. Such merchant data can also include predetermined communications to be communicated to customers, or predetermined criteria from which the digital compensation module can determine communications to be communicated to customers. For example and not limitation, such merchant data can include communication templates and offers to communicate to customers. In some embodiments, communications to the digital compensation module 206 can include instructions to determine a communication to be communicated to a customer or customers. In other embodiments, instructions are stored in the digital compensation module 206 and may be merchant-specific, or able to be applied to more than one merchant's digital compensation functionality.

In some embodiments, the digital compensation module 206 is configured to receive, via a receiver 256, a signal from the merchant server 202. The receiver 256 can be configured to be in communication with the communications processor 216 and the digital compensation processor 246 to receive information from the merchant server 202 and determine the format and content of a communication to be sent to a customer. The digital compensation processor 246 can be configured to determine whether to provide digital compensation to a customer, an amount and type of digital compensation to provide to a customer, as well as the rules and parameters to apply to that compensation. The digital compensation processor can be configured to receive data from the receiver 256, including instructions from the merchant regarding the rules and parameters for providing compensation. The digital compensation processor may also receive data from the communications processor 216, which might include information collected from the customer device processor 214 over network 210. The digital compensation processor 246 can also be configured to receive data from the digital wallet/virtual prepaid/customer benefit interface 226 to determine any further parameters imposed by those products or to determine any further information needed from the customer in order to provide those products. The digital compensation processor can also be configured to transmit data to the payment network compensation server 208 to provide the specific digital compensation required, such as digital compensation provided to a customer's digital wallet, virtual prepaid gift cards, or other customer benefits.

For example, and not limitation, the digital compensation module 206 can receive a notification from the merchant server 202 of an airline in the event of an overbooked flight. In such a case, the service condition monitor 222 could have received data from merchant memory storage 242 and triggered the service condition alarm 232. Utilizing data in merchant memory storage 242, the merchant processor 212, coupled to the service condition alarm 232, can be configured to transmit a notification to the digital compensation module 206 via the network 210. Within digital compensation module 206, the communications processor 216 can use information from the merchant to determine a communication to communicate to one or several customers, for example, the option of forfeiting a seat on the overbooked flight in exchange for a digital airline voucher. The customers can receive the communication via customer device 204 and, for example, can be prompted to select an amount of compensation for which they would be willing to forfeit their seat.

In another exemplary embodiment, the customer can be prompted to submit a specific amount of compensation, for example via their customer device 204, for which they would be willing to forfeit their seat. Such submitted information can be processed, in connection with the submitted amounts of compensation of other users, to determine, based for example on a bidding system, which passenger or passengers will be selected to forfeit their seat and receive the submitted amount of compensation. For example, and not limitation, the bidding system can be configured to provide digital compensation to a certain number of passengers based on a certain number of lowest bids, such as by providing digital compensation to the ten customers who submitted, respectively, the ten lowest bids. The system can also employ a first come, first served methodology wherein customers whose responses to the communication from the digital compensation module 206 are received first are processed, and customer responses received after the merchant's need for volunteers to forfeit seats is exhausted, or after a certain period of time defined by the merchant, are not processed.

In another exemplary embodiment, a customer can be prompted via the communication to select between different forms of compensation, which can include but are not limited to virtual prepaid gift cards, such as virtual prepaid gift cards sent to the customer's digital wallet, a transfer directly to their bank account, or a digital award of airline miles.

In another exemplary embodiment, the communications processor 216 can receive information from the service condition alarm 232 containing information from merchant memory storage 242 regarding the level of compensation or a minimum level of compensation that the airline would like to offer a passenger or passengers based on customer benefit information contained in merchant memory storage 242. A customer can be notified of an overbooked flight and be provided with such information, along with other customer benefit information, before being prompted to select whether to forfeit their seat in exchange for a certain amount and/or type of digital compensation.

In some embodiments, again with reference to the airline industry, the service condition monitor 222 can be configured to monitor delayed or canceled flights, information about which can be stored in merchant memory storage 242, monitored by the service condition monitor 222, and communicated to the service condition alarm 232 if data received or analyzed by the service condition monitor 222 indicates that a flight is delayed or canceled. Such data, as with other embodiments, can also include a list of passengers affected by that service condition. To compensate passengers for delayed or canceled flights, the digital compensation module 206 can be configured to receive notification from the merchant server 202, to determine a communication to send to the passenger, to communicate such message to the passenger, to determine whether digital compensation is appropriate and desired, and to provide such digital compensation.

In some embodiments, the digital compensation module 206 can access, via network 210, service condition information from merchant memory storage 242. For example and not limitation, digital compensation module 206 can access service condition information without receiving a notification originating from service condition alarm 232. In other embodiments, digital compensation module 206 can begin to access service condition information after receiving a first notification originating from service condition alarm 232, such that digital compensation module 206 can, after receiving a notification of a first change condition, monitor service condition information to determine if a second change condition occurs. In some embodiments, the digital compensation module 206 can be configured to generate, via communications processor 216, an additional communication or communications to customers, for delivery over network 210 to customer devices 204, after determining that a second change condition has occurred. Additional communications can be sent containing, for example but not limitation, updated service condition information, further offers of digital compensation, or any other communication determined via instructions from the merchant.

In some embodiments, in the context of the airline industry, the digital compensation module 206 can be configured to determine if a passenger's flight has been rescheduled to the following day. In that context, the digital compensation processor 246 can be configured to indicate, to the merchant server 202, that a need exists to generate a hotel voucher. The digital compensation module can, via network 210, request their airline to confirm, either automatically or via a request to an agent, that the digital compensation module 206 should generate a digital hotel voucher. In some embodiments, the merchant server 202 can be configured to transmit, via network 210, to the digital compensation module 206, instructions for generating the digital hotel voucher and parameters to be applied to the digital hotel voucher.

In some embodiments, the determined digital compensation can be proposed to an airline agent before it is provided to the passenger, and the airline agent can determine whether the determined compensation will be provided. In the case of digital compensation to compensate for a delayed or canceled flight, such digital compensation can include digital prepaid vouchers with parameters applied by the merchant restricting the timing or place of use, for example, restricting the use of digital prepaid vouchers to within an airport terminal, and/or restricting the use of digital vouchers to a certain period of time, such as until a passenger's rescheduled flight leaves. Such vouchers can, for example, be used by passengers to buy food and drink while they wait at an airport terminal. In another example, a digital prepaid voucher may be restricted for use at nearby hotels, intended to be used for accommodations if customers' rescheduled travel plans require an overnight stay.

In some embodiments, the communications processor 216 can be configured to communicate with customers via a conversational artificial intelligence program (i.e., a “chatbot”) that can adaptively communicate with customers over the internet, whether by SMS, social network account, e-mail, via an interactive website, or any other communications medium or interface.

In addition to providing a more convenient and efficient method for providing compensation to customers, the methods and systems disclosed herein can provide enhanced security over prior art systems and methods. For example, digital compensation provided directly to a customer's bank account, miles delivered to a customer's account associated with an airline, or virtual prepaid gift cards cannot be lost, stolen, or destroyed in the same manner as traditional paper vouchers.

In conjunction with providing digital compensation, the digital compensation processor 246 can also communicate information, for example but not limited to a digital prepaid card number, via network 210, to a customer device or devices 204, to allow access to other merchant services. For example, in the case of airline travel, a passenger who forfeits their seat in exchange for digital compensation will likely still need to be rebooked on a new flight to substitute for their forfeited seat. In that case, the digital compensation processor 246 can provide the passenger a digital prepaid card number for use in an airline system, in person or via the internet, or via a user interface supported by the digital compensation module 206 itself using information received from merchant server 202 via network 210, or using data residing on merchant server 202 and accessed via network 210, to allow the passenger to book a new flight on the airline at that time or at a later time. In another embodiment, digital compensation processor 246 can provide the customer with a digital prepaid card number to book hotel accommodations, and such booking can similarly be accomplished using a merchant hotel system, in person or via the internet, or via a user interface supported by the digital compensation module 206 itself using data received from merchant server 202 via network 210, or using data residing on merchant server 202 and accessed via network 210.

In some embodiments, the communications processor 216 can be configured to communicate to customers using one or more communication media, including but not limited to SMS, social media message, e-mail, or through one or more communication media with a link to an interactive website.

In some embodiments, the payment network compensation server 208 can be configured to offer events and experiences through the events and experiences engine 218. In some embodiments, the offers engine 228 can generate and process offers for customers in conjunction with the digital compensation determined and offered via the digital compensation module 206. For example, and not limitation, a customer of an airline who is ticketed on an overbooked flight and chooses to forfeit his or her seat in exchange for a digital prepaid voucher or other digital compensation, may further receive offers initiated by the offers engine 228 and may further be informed of events and experiences initiated by the events and experiences engine 218. The events and experiences engine 218 and the offers engine 208 can be configured to receive information from payment network compensation memory 228, which can store and provide information related to activities, events, experiences, or offers in various locations and at various time periods. In some embodiments, the events and experiences engine 218 and the offers engine 228 can select events and experiences for the customer based on the location of the airport from which the subject flight was scheduled to depart. Any events, experiences, or offers communicated to the customer may be communicated via network 210, from the payment network compensation server 208, to a customer device 204.

In some embodiments, after digital compensation has been provided, the status of that digital compensation may be monitored by the redemption tracking module 236. For example, after a customer is provided digital compensation, the redemption tracking module 236 may keep a record of the provision of that compensation and may receive data indicating whether that digital compensation has been used, and if so, how much of the digital compensation remains. Such digital compensation that has been used may have been in the form of digital prepaid vouchers or digital airline voucher. If the compensation is a digital airline voucher, the payment network may not have a role in the processing of the transaction in which the digital compensation is used, but information may still be received by the redemption tracking module 236. In this manner, the disclosed system can monitor the status of digital compensation even if payments are not being processed by the payment network at the time of redemption. In this manner, the system can act, after provision of digital compensation, as a transactional accounting system.

In some embodiments, the status of digital compensation can be monitored via customer device 204. For example, customer device 204 can access data via network 210 regarding the remaining balance of digital compensation remaining.

For example and not limitation, digital compensation can be redeemed in many ways, including but not limited to via account card, QR code, virtual prepaid card number, via near-field communication (NFC) device, or via any merchant-accepted payment method associated with digital compensation.

As another example, merchants often want to provide benefits to customers, for example to reward customer loyalty in the form of, for example, repeat business. Those benefits are provided in a number of ways, for example through paper vouchers, and there exists a need to provide greater efficiency and convenience by providing those benefits as digital compensation. The disclosed methods and systems could, for example, be used to provide and process the redemption of airline companion tickets in the form of digital benefits. Digital compensation processor 246 could receive a notification from merchant server 202 for the need to process an airline companion ticket, communications processor 216 could communicate with customer device 204 to send and receive any necessary information for completing the transaction, and digital compensation processor 246 can provide digital compensation in the form of a digital airline companion ticket to a digital account accessible and redeemable, for example, via customer device 204.

In some embodiments, digital compensation processor 246 can provide digital compensation to hotel guests. Hotels often provide free breakfast and other meals, or discounted vouchers redeemable at service providers of the hotel or surrounding area. The methods and systems disclosed can be configured to provide those benefits as digital compensation. For example, merchant processor 212 and service condition monitor 222 can be configured to determine if a hotel guest should receive a free meal or a voucher for services that the guest arranged, for example, with a concierge. Such benefits could be one of a plethora of services or experiences offered through the hotel. In that case, the digital compensation processor 246 could receive notification from the merchant server 202 that a guest of the hotel should be contacted and digital compensation should be provided. Digital compensation processor 246, in conjunction with the communications processor 216 can determine a communication to send to the customer via their customer device 204, and after receiving confirmation that the customer would like to receive certain benefits via one of a number of options of digital compensation, such digital compensation can be provided by the digital compensation processor 246. Currently, hotels do not have a means to track usage of many services and the methods and systems disclosed herein can function as a transaction accounting system through the redemption tracking module 236 across merchant-types in the same manner as in the airline industry example above. Accordingly, regardless of whether the payment network has a role in processing the ultimate transaction of the digital compensation after it is provided, the redemption tracking module 236 can monitor the status of digital compensation and provide information on digital compensation usage, or outstanding digital compensation, to merchants.

In some embodiments, the merchant server 202 can provide digital compensation module 206 with such information to allow the digital compensation module 206 to function as an interface via an interactive website for customers to select and receive digital prepaid vouchers via a customer device 204, whether the cost of the vouchers is pre-paid by customers or offered from the merchant for specific uses without the need for explicit pre-payment by the customer.

As embodied herein, digital compensation module 206 and its subcomponents described herein may be embodied in various configurations of processing circuitry. In some embodiments, digital compensation module 206 can comprise processing circuitry at one physical location, and in other embodiments, digital compensation module 206 may comprise processing circuitry in more than one physical location.

As embodied herein, payment network compensation server 208 and its subcomponents described herein may be embodied in various configurations of processing circuitry. In some embodiments, payment network compensation server 208 and its subcomponents can comprise processing circuitry at one physical location, and in other embodiments, payment network compensation server 208 may comprise processing circuitry in more than one location.

In some embodiments, digital compensation module 206 and payment network compensation server 208 can be configured as integrated processing circuitry at a single physical location or in more than one physical location.

In alternative embodiments, the components of the described system for providing digital compensation may comprise processing circuitry in one or several physical locations configured to operate as described via application program interfaces (API's).

FIG. 3 is a flow chart illustrating a representative method 300 implemented according to an illustrative embodiment of the disclosed subject matter. The exemplary network 100 of FIG. 1 and system 200 of FIG. 2, for purpose of illustration and not limitation, are discussed with reference to the exemplary method of FIG. 3.

As embodied herein, at 310, processing circuitry can receive a notification of a change condition accompanied by instructions to communicate with the customer. Notification of a change condition can include any information designated by a merchant to be relevant to the communication to be formed by the digital compensation module 206, to be transmitted to the customer via network 210 to customer device 204. The notification can also be accompanied by instructions regarding the content of communications to send, the parameters or rules to ultimately apply to any provided digital compensation, and other customer information that the digital compensation module will need in order to perform its functions, including but not limited to customer name and customer account information if known by the merchant.

The notification can also include other information describing the relationship between the merchant and customer, including but not limited to customer status information or eligibility information related to customer loyalty. Such information can be used within the merchant server to identify customers to be notified by the digital compensation module 206, and such information can further be utilized by the digital compensation module in communicating with the customer and processing and providing digital compensation. For example, customer information related to levels of status can be communicated to the digital compensation module 206, and customers can be contacted in order of their status level. In the alternative, customers of varying status levels can all be notified at the same time, but customers of a higher status level can be provided with offers representing greater values of digital compensation, or can ultimately be offered further benefits via the digital compensation module 206 or the payment network compensation server 208.

At 320, processing circuitry can determine a communication to send to the customer containing offers and options to select regarding those offers. The communications processor 216, in conjunction with the digital compensation processor 246, can use information from the merchant server 202 to determine which passengers to communicate with, and to determine the format and content of those communications. Offers to customers can include, in the airline context, the option to forfeit a customer's seat in exchange for a digital prepaid voucher. At this step, it can also be determined whether certain forms of digital compensation will or will not be offered to one or more customers.

At 330, the processor can transmit the communication to the customer. The communication to the customer can be sent via e-mail, SMS, social network account, or any other available communication method, such as those described in reference to FIG. 1. Such a communication method can be pre-selected by the customer or can be selected by the merchant server 202 or digital compensation module 206 based on the available customer information.

At 340, the receiver 256, comprising processing circuitry, can receive one or more selections from the customer. Such selections can include answers to questions posed by the communication sent to customer device 204. In the context wherein a communication is sent on behalf of an airline merchant indicating a service condition of an overbooked flight, the receiver can receive the customer's selection of whether to forfeit their seat in exchange for digital compensation, and if they do choose to forfeit their seat, can receive the customer's selection of digital compensation format and/or amount of digital compensation, depending on the options made available to the customer.

At 350, the digital compensation processor 246 can determine whether the selection received from the customer includes a selection of any compensation. Such selection may be explicit, for example if the customer selects a format and amount of digital compensation from a list of options offered to the customer. Alternatively, the selection may be implicit, i.e. if based on the customer's response, the customer is made eligible, based on criteria provided to the digital compensation processor 246 from the merchant server 202, to receive some customer benefit in the form of digital compensation.

At 360, if the processor determines at step 350 that no compensation is to be provided, the processor will not provide digital compensation.

At 370, the digital compensation processor 246 can determine, based on information received from the merchant server 202 and from the customer device 204, the type and amount of digital compensation to provide to the customer, as well as any parameters to apply to the digital compensation. For example, but not limitation, a merchant might apply restrictions on the time period during which compensation may be used or reimbursed, or a merchant might apply restrictions on the place or type of business establishment at which compensation may be used or reimbursed. In other words, the digital compensation can be assigned one or more “types” that limit the categories of businesses with which the digital compensation may be exchanged or redeemed. For example and not limitation, the merchant can apply a parameter to the digital compensation to limit the category of business with which it can be exchanged to “dining,” for example if the digital compensation was offered in the first instance because the service condition alarm 232 was triggered by data indicating that a passenger's flight had been delayed.

At step 380, the digital compensation processor can provide digital compensation to the customer.

FIG. 4 is a block diagram illustrating further details of a representative computer system according to an illustrative embodiment of the disclosed subject matter.

The systems and techniques discussed herein can be implemented in a computer system. As an example and not by limitation, as shown in FIG. 4, the computer system having architecture 400 can provide functionality as a result of processor(s) 401 executing software embodied in one or more tangible, non-transitory computer-readable media, such as memory 403. The software implementing various embodiments of the present disclosure can be stored in memory 403 and executed by processor(s) 401. A computer-readable medium can include one or more memory devices, according to particular needs. Memory 403 can read the software from one or more other computer-readable media, such as mass storage device(s) 435 or from one or more other sources via communication interface 420. The software can cause processor(s) 401 to execute particular processes or particular parts of particular processes described herein, including defining data structures stored in memory 403 and modifying such data structures according to the processes defined by the software. An exemplary input device 433 can be, for example, a keyboard, a pointing device (e.g. a mouse), a touchscreen display, a microphone and voice control interface, or the like to capture user input coupled to the input interface 423 to provide data and/or user input to the processor 401. An exemplary output device 434 can be, for example, a display (e.g. a monitor) or speakers coupled to the output interface 424 to allow the processor 401 to present a user interface, visual content, and/or audio content. Additionally, or alternatively, the computer system 400 can provide an indication to the user by sending text or graphical data to a display 432 coupled to a video interface 422. Furthermore, any of the above components can provide data to or receive data from the processor 401 via a computer network 430 coupled the communication interface 420 of the computer system 400. In addition or as an alternative, the computer system can provide functionality as a result of logic hardwired or otherwise embodied in a circuit, which can operate in place of or together with software to execute particular processes or particular parts of particular processes described herein. Reference to software or executable instructions can encompass logic, and vice versa, where appropriate. Reference to a computer-readable media can encompass a circuit (such as an integrated circuit (IC)) storing software or executable instructions for execution, a circuit embodying logic for execution, or both, where appropriate. The present disclosure encompasses any suitable combination of hardware and software.

In some embodiments, processor 401 includes hardware for executing instructions, such as those making up a computer program. As an example and not by way of limitation, to execute instructions, processor 401 can retrieve (or fetch) the instructions from an internal register, an internal cache 402, memory 403, or storage 408; decode and execute them; and then write one or more results to an internal register, an internal cache 402, memory 403, or storage 408. In particular embodiments, processor 401 can include one or more internal caches 402 for data, instructions, or addresses. This disclosure contemplates processor 401 including any suitable number of any suitable internal caches, where appropriate. As an example and not by way of limitation, processor 401 can include one or more instruction caches 402, one or more data caches 402, and one or more translation lookaside buffers (TLBs). Instructions in the instruction caches 402 can be copies of instructions in memory 403 or storage 408, and the instruction caches 402 can speed up retrieval of those instructions by processor 401. Data in the data caches 402 can be copies of data in memory 403 or storage 408 for instructions executing at processor 401 to operate on; the results of previous instructions executed at processor 401 for access by subsequent instructions executing at processor 401 or for writing to memory 403 or storage 408; or other suitable data. The data caches 402 can speed up read or write operations by processor 401. The TLBs can speed up virtual-address translation for processor 401. In some embodiments, processor 401 can include one or more internal registers for data, instructions, or addresses. This disclosure contemplates processor 401 including any suitable number of any suitable internal registers, where appropriate. Where appropriate, processor 401 can include one or more arithmetic logic units (ALUs); be a multi-core processor; or include one or more processors 401. Although this disclosure describes and illustrates a particular processor, this disclosure contemplates any suitable processor.

In some embodiments, memory 403 includes main memory for storing instructions for processor 401 to execute or data for processor 401 to operate on. As an example and not by way of limitation, computer system 400 can load instructions from storage 408 or another source (such as, for example, another computer system 400) to memory 403. Processor 401 can then load the instructions from memory 403 to an internal register or internal cache 402. To execute the instructions, processor 401 can retrieve the instructions from the internal register or internal cache 402 and decode them. During or after execution of the instructions, processor 401 can write one or more results (which can be intermediate or final results) to the internal register or internal cache 402. Processor 401 can then write one or more of those results to memory 403. In some embodiments, processor 401 executes only instructions in one or more internal registers or internal caches 402 or in memory 403 (as opposed to storage 408 or elsewhere) and operates only on data in one or more internal registers or internal caches or in memory 403 (as opposed to storage 408 or elsewhere). One or more memory buses (which can each include an address bus and a data bus) can couple processor 401 to memory 403. Bus 440 can include one or more memory buses, as described below. In particular embodiments, one or more memory management units (MMUs) reside between processor 401 and memory 403 and facilitate accesses to memory 403 requested by processor 401. In some embodiments, memory 403 includes random access memory (RAM). This RAM can be volatile memory, where appropriate. Where appropriate, this RAM can be dynamic RAM (DRAM) or static RAM (SRAM). Moreover, where appropriate, this RAM can be single-ported or multi-ported RAM. This disclosure contemplates any suitable RAM. Memory 403 can include one or more memories 404, where appropriate. Although this disclosure describes and illustrates particular memory, this disclosure contemplates any suitable memory.

In some embodiments, storage 408 includes mass storage for data or instructions. As an example and not by way of limitation, storage 408 can include a hard disk drive (HDD), a floppy disk drive, flash memory, an optical disc, a magneto-optical disc, magnetic tape, or a Universal Serial Bus (USB) drive or a combination of two or more of these. Storage 408 can include removable or non-removable (or fixed) media, where appropriate. Storage 408 can be internal or external to computer system 400, where appropriate. In some embodiments, storage 408 is non-volatile, solid-state memory. In some embodiments, storage 408 includes read-only memory (ROM). Where appropriate, this ROM can be mask-programmed ROM, programmable ROM (PROM), erasable PROM (EPROM), electrically erasable PROM (EEPROM), electrically alterable ROM (EAROM), or flash memory or a combination of two or more of these. This disclosure contemplates mass storage 408 taking any suitable physical form. Storage 408 can include one or more storage control units facilitating communication between processor 401 and storage 408, where appropriate. Where appropriate, storage 408 can include one or more storages 408. Although this disclosure describes and illustrates particular storage, this disclosure contemplates any suitable storage.

In some embodiments, input interface 423 and output interface 424 can include hardware, software, or both, providing one or more interfaces for communication between computer system 400 and one or more input device(s) 433 and/or output device(s) 434. Computer system 400 can include one or more of these input device(s) 433 and/or output device(s) 434, where appropriate. One or more of these input device(s) 433 and/or output device(s) 434 can enable communication between a person and computer system 400. As an example and not by way of limitation, an input device 433 and/or output device 434 can include a keyboard, keypad, microphone, monitor, mouse, printer, scanner, speaker, still camera, stylus, tablet, touch screen, trackball, video camera, another suitable input device 433 and/or output device 434 or a combination of two or more of these. An input device 433 and/or output device 434 can include one or more sensors. This disclosure contemplates any suitable input device(s) 433 and/or output device(s) 434 and any suitable input interface 423 and output interface 424 for them. Where appropriate, input interface 423 and output interface 424 can include one or more device or software drivers enabling processor 401 to drive one or more of these input device(s) 433 and/or output device(s) 434. Input interface 423 and output interface 424 can include one or more input interfaces 423 or output interfaces 424, where appropriate. Although this disclosure describes and illustrates a particular input interface 423 and output interface 424, this disclosure contemplates any suitable input interface 423 and output interface 424.

As embodied herein, communication interface 420 can include hardware, software, or both providing one or more interfaces for communication (such as, for example, packet-based communication) between computer system 400 and one or more other computer systems 400 or one or more networks. As an example, and not by way of limitation, communication interface 420 can include a network interface controller (NIC) or network adapter for communicating with an Ethernet or other wire-based network or a wireless NIC (WNIC) or wireless adapter for communicating with a wireless network, such as a WI-FI network. This disclosure contemplates any suitable network and any suitable communication interface 420 for it. As an example and not by way of limitation, computer system 400 can communicate with an ad hoc network, a personal area network (PAN), a local area network (LAN), a wide area network (WAN), a metropolitan area network (MAN), or one or more portions of the Internet or a combination of two or more of these. One or more portions of one or more of these networks can be wired or wireless. As an example, computer system 400 can communicate with a wireless PAN (WPAN) (such as, for example, a BLUETOOTH WPAN), a WI-FI network, a WI-MAX network, a cellular telephone network (such as, for example, a Global System for Mobile Communications (GSM) network), or other suitable wireless network or a combination of two or more of these. Computer system 400 can include any suitable communication interface 420 for any of these networks, where appropriate. Communication interface 420 can include one or more communication interfaces 420, where appropriate. Although this disclosure describes and illustrates a particular communication interface, this disclosure contemplates any suitable communication interface.

In some embodiments, bus 440 includes hardware, software, or both coupling components of computer system 400 to each other. As an example and not by way of limitation, bus 440 can include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCIe) bus, a serial advanced technology attachment (SATA) bus, a Video Electronics Standards Association local (VLB) bus, or another suitable bus or a combination of two or more of these. Bus 440 can include one or more buses 404, where appropriate. Although this disclosure describes and illustrates a particular bus, this disclosure contemplates any suitable bus or interconnect.

Herein, a computer-readable non-transitory storage medium or media can include one or more semiconductor-based or other integrated circuits (ICs) (such, as for example, field-programmable gate arrays (FPGAs) or application-specific ICs (ASICs)), hard disk drives (HDDs), hybrid hard drives (HHDs), optical discs, optical disc drives (ODDs), magneto-optical discs, magneto-optical drives, floppy diskettes, floppy disk drives (FDDs), magnetic tapes, solid-state drives (SSDs), RAM-drives, SECURE DIGITAL cards or drives, any other suitable computer-readable non-transitory storage media, or any suitable combination of two or more of these, where appropriate. A computer-readable non-transitory storage medium can be volatile, non-volatile, or a combination of volatile and non-volatile, where appropriate.

The foregoing merely illustrates the principles of the disclosed subject matter. Various modifications and alterations to the described embodiments will be apparent to those skilled in the art in view of the teachings herein. It will thus be appreciated that those skilled in the art will be able to devise numerous techniques which, although not explicitly described herein, embody the principles of the disclosed subject matter and are thus within its spirit and scope.

1. A method for providing digital compensation, comprising:
receiving, by processing circuitry, a notification from a merchant, of a change condition regarding a customer;
receiving, by the processing circuitry, instructions from the merchant, specifying at least one type of digital compensation to offer to the customer, an amount or amounts of compensation to offer to the customer, and at least one parameter to apply to compensation;
determining, by the processing circuitry, a communication to send to the customer;
transmitting the communication, by the processing circuitry, to the customer;
receiving, by the processing circuitry, at least one selection from the customer;
determining, by the processing circuitry, based on the at least one selection from the customer, whether to provide compensation to the customer;
determining, by the processing circuitry, based on the at least one selection from the customer, a compensation type and a compensation amount to provide to the customer; and
providing, by the processing circuitry, digital compensation to the customer based on the instructions from the merchant and the at least one selection from the customer.

2. The method of claim 1 wherein the communication to the customer includes communication of an option to forego services in exchange for digital compensation.

3. The method of claim 1 wherein the merchant is an airline, wherein the change condition includes one of a delayed flight, a canceled flight, or an overbooked flight, wherein the communication transmitted to the customer includes an option to forfeit the customer's seat in exchange for digital compensation, and wherein the type of digital compensation includes a digital airline voucher.

4. The method of claim 1, wherein the merchant is an airline, wherein the change condition is one of a delayed flight, an overbooked flight, or a canceled flight and wherein the communication to the customer includes an option to select a type of digital compensation, including one of a digital airline voucher, or digital compensation to which at least one parameter is applied to restrict redemption of the digital compensation to a particular place or to restrict redemption of the digital compensation to a particular time.

5. The method of claim 4, further comprising the steps of:
determining, by the processing circuitry, relevant information for the customer, based on a departure location of the delayed flight, a departure location of the overbooked flight, or a departure location of the canceled flight; and
transmitting, by the processing circuitry, the information to the customer.

6. The method of claim 1 wherein the merchant is an airline, wherein the change condition includes an overbooked flight, wherein the communication to the customer includes an option to forfeit a seat in exchange for digital compensation, wherein the type of compensation includes a digital airline voucher; and further including the steps of:
monitoring, by the processing circuitry, a redemption status of the digital compensation;
transmitting, by the processing circuitry to the merchant, a notification that the digital compensation has been partially or fully redeemed.

7. The method of claim 1, wherein providing digital compensation comprises providing, by the processing circuitry, a virtual prepaid gift card.

8. The method of claim 1, wherein providing digital compensation comprises providing, by the processing circuitry, digital compensation to a digital wallet associated with the customer.

9. The method of claim 1, wherein the at least one parameter to apply to the digital compensation includes at least one customer loyalty benefit.

10. The method of claim 1, wherein the merchant provides accommodations and wherein the at least one parameter to apply to the digital compensation includes limiting use of the digital compensation to one of a selected restaurant or a selected service provider, and further including the steps of:
monitoring, by the processing circuitry, a redemption status of the digital compensation;
and
transmitting, by the processing circuitry to the merchant, a notification that the digital compensation has been partially or fully redeemed.

11. A system for providing digital compensation, comprising:
processing circuitry configured to receive a notification from a merchant, of a change condition regarding a customer, and configured to receive, from the customer, at least one selection;
the processing circuitry being further configured to receive instructions from the merchant, specifying at least one type of digital compensation to offer to the customer, an amount or amounts of compensation to offer to the customer, and at least one parameter to apply to compensation;
the processing circuitry being further configured to:
determine a communication to transmit to the customer;
transmit the communication to the customer;
determine, based on the at least one selection from the customer, whether to provide compensation to the customer;
determine, based on the at least one selection from the customer, a compensation type and a compensation amount to provide to the customer; and
provide digital compensation to the customer of the type and amount selected, based on the instructions from the merchant and the at least one selection from the customer.

12. The system of claim 11 wherein the communication to the customer includes communication of an option to forego services in exchange for digital compensation.

13. The system of claim 11 wherein the merchant is an airline, wherein the change condition includes one of a delayed flight, a canceled flight, or an overbooked flight, wherein the communication to the customer includes an option to forfeit the customer's seat in exchange for digital compensation, and wherein the type of digital compensation includes a digital airline voucher.

14. The system of claim 11, wherein the merchant is an airline, wherein the change condition includes a delayed flight, an overbooked flight, or a canceled flight, and wherein the communication to the customer includes an option to select a type of digital compensation, including one of a digital airline voucher, or digital compensation to which at least one parameter is applied to restrict redemption of the digital compensation to a particular place or to restrict redemption of the digital compensation to a particular time.

15. The system of claim 14, wherein the processing circuitry is further configured to:
determine information relevant to the customer based on a departure location of the delayed flight, a departure location of the overbooked flight, or a departure location of the canceled flight; and
transmit the information to the customer.

16. The system of claim 11 wherein the merchant is an airline, wherein the change condition includes an overbooked flight, wherein the communication to the customer includes an option to forfeit a seat in exchange for digital compensation, and wherein the type of compensation includes a digital airline voucher; the processing circuitry being further configured to:
monitor a redemption status of the digital compensation; and
transmit to the merchant, a notification that the digital compensation has been partially or fully redeemed.

17. The system of claim 11, wherein the processing circuitry is further configured to provide the digital compensation in the form of a virtual prepaid gift card.

18. The system of claim 11, wherein the processing circuitry is further configured to provide digital compensation to a digital wallet associated with the customer.

19. The system of claim 11, wherein the at least one parameter to apply to the digital compensation includes at least one customer loyalty benefit.

20. The system of claim 11, wherein the merchant provides accommodations and wherein the at least one parameter to apply to the digital compensation includes limiting use of the digital compensation to one of a selected restaurant or a selected service provider, and further including the processing circuitry being configured to:
monitor a redemption status of the digital compensation; and
transmit to the merchant, a notification that the digital compensation has been partially or fully redeemed.
